(19) United States
(12) Patent Application Publication
(10) Pub. No.: US 2012/0010119 A1
(43) Pub. Date: Jan. 12, 2012

(54) AZEOTROPIC AND NEAR-AZEOTROPIC MIXTURES OF HEXAMETHYLDISILOXANE AND DIMETHYL CARBONATE AND METHODS OF USE

(75) Inventor: Wells Cunningham, New Hartford, CT (US)

(73) Assignee: ZYNON TECHNOLOGIES, LLC, New Britain, CT (US)

(21) Appl. No.: 13/178,219

(22) Filed: Jul. 7, 2011

Related U.S. Application Data
(60) Provisional application No. 61/363,046, filed on Jul. 9, 2010.

(51) Int. Cl. C11D 17/00; B05D 7/24; B05D 3/00; C09K 3/00

(52) U.S. Cl. 510/411; 252/182.3; 427/372.2

(57) ABSTRACT

A blend of hexamethyldisiloxane and dimethyl carbonate displays azeotropic behavior over a surprisingly broad composition range of from about 10% to about 90% by weight dimethyl carbonate. The blends are useful for degreasing, precision cleaning and flux removal from soldered articles, as well as a carrier liquid for particulates such as particulate polytetrafluoroethylene lubricant. Increasing amounts of dimethyl carbonate in the blend provide a more aggressive cleaner. Methods for cleaning, degreasing and flux removal include applying the blends of the invention to articles and drying the articles by drying the applied blends or allowing the applied blends to evaporate. Methods of applying a dispersion of fine particulate material to a surface include utilizing the blends of the invention as a carrier liquid for the particulates and applying the particulate-laden carrier liquid to a surface and removing the carrier liquid by evaporation to leave the dispersed particulates behind. Another valuable use of the MM/DMC blends is to employ them as carrier liquids for deposition of normally insoluble silicone oils and polymers onto or into an article and then drying or allowing the applied carrier liquid to dry by evaporation in order to leave behind a uniform film of coating.

### CROSS-REFERENCE TO RELATED APPLICATION

This application claims the benefit of priority of provisional patent application Ser. No. 61/363,046, filed on Jul. 9, 2010, entitled “Azeotropic and Near-Azeotropic Mixtures of Hexamethyldisiloxane and Dimethyl Carbonate and Methods of Use”.

### BACKGROUND OF THE INVENTION

1. Field of the Invention

The present invention generally concerns azeotropic or near-azeotropic blends of hexamethyldisiloxane and dimethyl carbonate, which blends are suited for use as cleaners, degreasers, flux removers, carrier liquids and the like.

2. Related Art

U.S. Pat. No. 5,773,403, issued Jun. 30, 1998 to M. Hijino et al., discloses a cleaning and drying solvent which finds use as a hand-cleaning agent, a precise cleaning agent and a drying agent for industrial parts. The solvent comprises a siloxane compound which may be hexamethyldisiloxane, an azeotropic or azeotrope-like composition of hexamethyldisiloxane and a lower alcohol, or a mixture of hexamethyldisiloxane and each of ketones, carboxylic esters, low molecular weight saturated hydrocarbons and/or low molecular weight alcohols. See the Abstract, which describes an azeotropic or azeotrope-like composition of hexamethyldisiloxane and each of ketones, carboxylic esters, etc. Column 4 discloses specific proportions of the hexamethyldisiloxane and various alcohols needed to attain an azeotropic or azeotrope-like mixture. Column 5, lines 1-3, calls for a mixture of hexamethyldisiloxane with at least one organic compound selected from among ketones, carboxylic esters, saturated C₁-C₈ hydrocarbons and C₃-C₅ alcohols, giving examples of specific organic compounds.

U.S. Pat. No. 5,478,493, issued Dec. 26, 1995 to Ora L. Flaningam et al., discloses binary azeotropes of hexamethyldisiloxane with certain alcohols, and their use as cleaning agents. The alcohol component of the binary azeotrope is 3-methyl-3-pentanol C₂H₅C(CH₃)(OH)C₂H₅; 2-pentanol CH₃CH₂CH₂CH(OH)CH₃, or 1-methoxy-2-propanol CH₃OCH₂CH(CH₃)OH.

U.S. Pat. No. 5,834,416, issued Nov. 10, 1998 to David Lee Morgan et al., discloses binary azeotrope and azeotrope-like compositions containing the alkyl esters n-propyl acetate and sec-butyl acetate, respectively, with hexamethyldisiloxane. The compositions are stated to be useful for cleaning, rinsing, or drying.

U.S. Pat. No. 5,628,833, issued May 13, 1997 to Cheryl A. McCormack et al., discloses a washing composition containing a volatile methyl siloxane such as hexamethyldisiloxane or octamethyltrisiloxane, and an agent such as a glycol ether or a surface active agent for enhancing cleaning or dewatering of articles. A cleaning or dewatering process comprises rinsing a surface which is still wet with the washing composition with an azeotrope containing hexamethyldisiloxane or octamethyltrisiloxane, and 2-pentanol, 2-methyl-1-pentanol, 3-methyl-3-pentanol, 1-methoxy-2-propanol, 1-butoxy-2-propanol, 1-hexanol, n-propoxypropanol, or ethyl lactate. The surface is then dried or permitted to dry.

Dow Corning manufactures a product sold as OS-120 that is commercially available from MicroCare Corporation of Bristol, Conn. under the trademark VeriClean DC1. This product is a blend of hexamethyldisiloxane and 12% (by weight) 1-methoxy-2-propanol. Hexamethyldisiloxane is exempt from classification as a volatile organic compound, but 1-methoxy-2-propanol is not. Dow Corning holds U.S. Pat. No. 5,478,493 on blends of 8% to 18% (by weight) 1-methoxy-2-propanol with hexamethyldisiloxane because of the unexpected finding that in that composition range an azeotrope is formed.

### SUMMARY OF THE INVENTION

Generally, the present invention provides blends of hexamethyldisiloxane (sometimes below referred to as “MM”) and dimethyl carbonate (sometimes below referred to as “DMC”) which, within a certain, surprisingly large composition range, provide azeotropic or near-azeotropic blends. Such blends, i.e., mixtures, find use as carrier liquids for particulates, such as particulate lubricants, for example, particulate polytetrafluoroethylene particulates, carrier fluids for silicone fluid deposition and other coatings and for degreasing and cleaning of articles, for flux removal from soldered components or the like, and for precision cleaning generally, especially in industrial applications. The blends of MM and DMC in accordance with the present invention may be dispensed by aerosol, pump spray or by any other suitable (non-aerosol and non-pump spray) dispensing technique and are well-suited for industrial cleaning, degreasing and the like.

Specifically, in accordance with the present invention, there is provided an azeotropic blend of from about 90 weight % to about 10 weight % hexamethyldisiloxane (“MM”) and from about 10 weight % to about 90 weight % dimethylcarbonate (“DMC”).

Other aspects of the present invention provide azeotropic blends comprising from about 20 weight % to about 90 weight % MM and from about 80 weight % to about 10 weight % DMC, or about 50 weight % each of MM and DMC, or from about 90 weight % to about 85 weight % MM and from about 10 weight % to about 15 weight % DMC. When other components are present in the blend, the foregoing weight percents of MM and DMC may be present as respective parts by weight in the blend.

The azeotropic blend of the present invention may comprise a binary azeotropic blend consisting essentially of MM and DMC or, alternatively, it may contain other components such as stabilizers or the like, or it may serve as a carrier liquid for lubricants or coatings.

The azeotrope blends of the present invention may comprise a carrier liquid for lubricants or other coatings which are dissolved or suspended in the blends.

A method aspect of the present invention provides for cleaning an article, the method comprising: (a) contacting the article with a cleaning liquid comprising from about 10 to about 90 parts MM and from about 90 to about 10 parts DMC, and (b) removing the cleaning liquid from the article, e.g., by evaporating the cleaning liquid to remove it from the article.

Another aspect of the present invention provides that the cleaning liquid may comprise a binary azeotropic blend containing from about 10 to about 90 weight % MM and from about 90 to about 10 weight % DMC.

Another aspect of the invention provides a method of dispersing a substance onto an article, the method comprising: (a) dispersing the substance into a carrier liquid comprising an azeotropic or azeotrope-like blend of from about 90 parts by weight MM to about 10 parts by weight DMC; and (b) removing the carrier liquid to leave a coating of the substance on the article.

In one aspect, step (b) of the dispersing method comprises evaporating the cleaning liquid to remove it from the article, and in another aspect, the cleaning liquid may comprise a binary azeotropic blend containing from about 10 to about 90 weight % MM and from about 90 to about 10 weight % DMC.

As used herein and in the claims, the term “azeotrope-like” is intended to embrace blends which approximate azeotropic behavior, as is generally understood in the art.

### DETAILED DESCRIPTION OF THE INVENTION AND SPECIFIC EMBODIMENTS THEREOF

As those skilled in the art will appreciate, an azeotrope or a blend of materials having an azeotrope-like characteristic of a constant or nearly constant boiling point, is extremely useful in many fields, particularly when the blend, i.e., mixture, is utilized as a cleaning or degreasing agent in automated cleaning operations. In such operations, the blend is applied to the articles to be cleaned, whether by spraying, dipping or brush application, to remove grease and other contaminants from the articles. The blend containing the contaminants is then separated from the articles being cleaned and treated to remove contaminants from the blend. Such treatment may, for example, comprise evaporating the blend at a temperature which leaves the contaminants behind in the evaporator pot and then condensing the distillate to provide a recycled cleaning liquid. The cleaning liquid comprises a blend comprising an azeotrope or having azeotrope-like characteristics, the constant boiling temperature leaves a proportion of the azeotrope components and both the contaminated liquid and the distillate the same or approximately the same. This avoids the necessity of having to measure the proportion of ingredients in the blend, and supply make-up blend components in a proportion necessary to re-establish the initial desired proportions.

The MM/DMC blends of the present invention have a variety of uses including rinsing or cleaning parts which have previously been cleaned with stronger cleaning agents in order to remove residues and spots left by the stronger cleaning agents. The blends of the present invention may be used in the form of aerosols or pump sprays in various industrial applications including the cleaning of optical lenses and the like. They also find utility as carrier liquids for depositing lubricants such as silicone oils and greases or a carrier liquids for depositing fine particulates in fine particulate materials along the surface as the carrier liquid evaporates or as a cleaning liquid for cleaning contaminated surfaces and household and industrial cleaning applications. Any of the proportions of MM and DMC disclosed herein may be used for any of the uses of the present invention.

Azeotropic blends of hexamethyldisiloxane and dimethyl carbonate containing from about 10% to about 90% by weight dimethyl carbonate, for example, from about 20% to about 80% by weight dimethyl carbonate. These blends provide an azeotrope or at least exhibit near-azeotropic behavior. The boiling point at atmospheric pressure of these blends is about 189° F. to about 190° F. (87.2° C. to 87.8° C.). This is below the respective boiling points at atmospheric pressure of the components of the blend, MM having a boiling point of about 212° F. (100° C.) and DMC having a boiling point of about 194° F. (90° C.).

A method for cleaning or degreasing articles includes applying the MM/DMC blend of the invention to an article and drying the blend or allowing it to dry by evaporation. When cleaning plastic surfaces such as acrylic or polycarbonate plastics, the binary blend of the invention preferably contains from about 10 weight % to about 15 weight % DMC. For more aggressive cleaning of metal, ceramics and engineering plastics, the binary blend of the invention may contain more than about 15 weight % DMC, for example, from about 16 weight % up to about 90 weight % DMC, or about 20 weight % to about 80 weight % DMC.

Another use for the MM/DMC blends of the present invention is use as a flux removing agent for removing flux from soldered articles by applying the MM/DMC blend to the flux to remove the same, and drying or allowing the blend to dry by evaporation.

Yet another use of the MM/DMC blends of the present invention is to employ them as carrier liquids for distributing fine particulate materials onto or into an article and then drying or allowing the applied carrier liquid to dry by evaporation in order to leave behind a dispersion of the fine particulate materials, for example, particles of a lubricant such as polytetrafluoroethylene, or any suitable coating or lubricant.

Another valuable use of the MM/DMC blends is to employ them as carrier liquids for deposition of normally insoluble silicone oils and polymers onto or into an article and then drying, or allowing the applied carrier liquid to dry by evaporation, in order to leave behind a uniform film of coating.

Blends of MM and a number of other compounds were made and the respective boiling points of the blends were measured. (All boiling points described herein, unless otherwise specified, are boiling points at atmospheric pressure.) Binary blends of MM with, respectively, acetone, methyl acetate, methyl formate, ethyl acetate, propylene carbonate, DMC and t-butyl acetate were tested. Each of these compounds, like MM, is exempt from classification as a volatile organic compound (“VOC”). A list of “VOC exempt” materials is provided by the Southern California Air Quality Management Department and identifies compounds and mixtures of compounds which do not release significant amounts of volatile organic compounds into the atmosphere. Obviously, environmental considerations warrant reduction or elimination of materials which are not VOC exempt.

Initial test screening to ascertain boiling points of the blends was carried out on binary blends of MM with each of the above-noted compounds. A blend of 90 weight % MM and 10 weight % DMC was initially tested for the MM/DMC combination. (Unless otherwise specified, all percentages of components in a blend described herein are percentages by weight.) The results shown in Table I were attained.

TABLE I
Boiling Points (“BP”) of Solvent Blends With MM

| | | Ratio MM/ | |
|---|---|---|---|
| | BP of Solvent, | Solvent in | BP of Mixture, |
| Blended Solvent | ° F. (° C.) | the Blend | ° F. (° C.) |
| Acetone | 134 (56.7) | 90/10 | 157 (69.4) |
| Methyl Acetate | 134 (56.7) | 90/10 | 165 (73.9) |
| Ethyl Lactate | 303 (150.6) | 90/10 | 165 (73.9) |
| Propylene Carbonate | 464 (240.0) | 90/10 | 212 (100) |
| Tert-Butyl Acetate | 208 (97.8) | 90/10 | 208 (97.8) |
| Dimethyl Carbonate | 195 (90.6) | 90/10 | 189 (87.2) |

As shown by the results of Table I, the blend of MM and DMC was the only blend among those tested to boil below both the respective boiling points of either component of the blend thereby demonstrating the existence of an azeotrope or at least azeotrope-like behavior. The blend of 90 weight % MM and 10 weight % t-butyl acetate (tertiary butyl acetate) boiled at 208° F. (97.8° C.), which is the boiling point of t-butyl acetate, and which is 4° F. (2.2° C.) below the 212° F. (100° C.) boiling point of MM. This suggests that the blend of t-butyl acetate and MM appears to form an azeotrope or at least exhibit azeotrope-like properties, at least at the 90 weight %/10 weight % ratio tested. However, because of the strong, unpleasant smell of the MM/t-butyl acetate blend, further work was not done with that blend. The odor of the blends of the present invention is agreeable and much less offensive than the odors of cleaning liquids containing acetone, t-butyl acetate or other propylene glycol ethers.

The MM and DMC blend boiled at about 189° F. to about 190° F. (87.2° C. to 87.8° C.) over a surprisingly large composition range. This indicates that an azeotrope has been formed. There is no reason to predict that DMC would form an azeotrope with MM and that the other tested compounds (except for t-butyl acetate) would not. Further testing showed that the boiling point of the MM/DMC blend remained depressed relative to the respective boiling points of MM and DMC over a composition range of about 10 weight % to about 90 weight % DMC. The apparent existence of an azeotrope over such a broad range is very surprising.

The following Table II shows the results of a distillation of an MM/DMC blend which shows that an azeotrope or azeotrope-like blend is formed.

TABLE II
Distillation and analysis of a 506 gram sample of a blend of 36%
DMC/64% MM wt./wt. analysis of fractions by gas chromatography

| | | | | DISTILLATE | |
|---|---|---|---|---|---|
| Fraction | Weight | Pot Temp. | Head Temp. | Weight % | Weight % |
| Number | (gm) | ° F. (° C.) | ° F. (° C.) | MM | DMC* |
| 1 | 30 | 186 (85.6) | 180 (82.2) | 51.26 | 48.49 |
| 2 | 48 | 187 (86.1) | 180 (82.2) | 51.62 | 48.38 |
| 3 | 61 | 187 (86.1) | 180 (82.2) | 52.09 | 47.91 |
| 4 | 56 | 189 (87.2) | 180 (82.2) | 52.51 | 47.49 |
| 5 | 59 | 192 (88.9) | 180 (82.2) | 53.60 | 46.40 |
| 6 | 61 | 204 (95.6) | 183 (83.9) | 56.21 | 43.79 |
| 7 | 46 | 206 (96.7) | 186 (85.6) | 61.38 | 38.56 |
| 8 | 46 | 212 (100) | 212 (100) | 96.70 | 3.29 |
| Still bottom | 99 | | | 100.00 | 0.00 |

*Differences from 100% total are due to rounding errors and trace impurities.

The boiling points of the azeotropic blends (the “Pot Temp.”) are seen to be lower than the respective boiling points of DMC (194° F., 90° C.) and MM (212° F., 100° C.) over a temperature range of 186° F. (85.6° C.) to 192° F. (88.9° C.). This narrow boiling point range and the nearly constant weight ratios of the distillate over a substantial volume of DMC removal establishes that an azeotrope or azeotrope-like material is formed. As shown in the above Table I, the weight percentage of the formed azeotrope is close to approximately 50 weight % DMC/50 weight % MM for pot temperatures up to 192° F. (88.9° C.).

The following Table III shows the results of testing the boiling points of various blends of MM and DMC containing from 10 weight % to 90 weight % of each component in 10 weight % increments. The boiling point of MM is 212° F. (100° C.) and the boiling point of DMC is 195° F. (90.6° C.). (Unless expressly otherwise noted, all boiling points herein and in the claims are boiling points at atmospheric pressure.)

TABLE III
Boiling Points of Blends of MM and DMC

| Weight | Weight | |
|---|---|---|
| Percent | Percent | Boiling Point, |
| MM | DMC | ° F. (° C.) |
| 90 | 10 | 192 (88.9) |
| 80 | 20 | 188 (86.7) |
| 70 | 30 | 185 (85.0) |
| 60 | 40 | 185 (85.0) |
| 50 | 50 | 184 (84.4) |
| 40 | 60 | 183 (83.9) |
| 30 | 70 | 183 (83.9) |
| 20 | 80 | 185 (85.0) |
| 10 | 90 | 188 (86.7) |

The depressed boiling points over this wide range of mixtures demonstrate the azeotropic behavior of blends of MM and DMC.

As Table III shows, over the entire composition range of 10 weight % to 90 weight % MM, balance DMC, the blend of MM and DMC maintains a boiling point which is depressed relative to the respective boiling points of MM and DMC, indicating the formation of an azeotrope or at least azeotrope-like behavior. Only at 90 weight % MM does the blend come within 3° F. (1.7° C.) of the boiling point of DMC; from 10 weight % to 80 weight % MM, the boiling point of the blend ranges from 7 to 12° F. (3.9 to 6.7° C.) below the boiling point of the lower-boiling DMC.

The blends of MM and DMC evaporate faster than either component individually. This is a benefit for cleaning operations because it prevents “puddling” and wash-back of contamination onto cleaned areas. At about 10 weight % to about 15 weight % DMC in the blend of MM and DMC, plastic surfaces are not damaged. For example, acrylic and polycarbonate plastics were cleaned with blends of 10 weight % to 15 weight % DMC with MM, without damage to the plastics. This cleaning product could therefore be certifiable as “plastic safe”, at least for acrylics and polycarbonates. It is believed that this 10 weight % to 15 weight % blend will also be safe for other plastics. Higher concentrations of DMC in the blend provide a more aggressive cleaner which is suitable for metals, glass, ceramics and engineering plastics. The odor of the blends is agreeable and by consensus is deemed to be less offensive than acetone, t-butyl acetate or propylene glycol ethers generally.

Two 100 gram blends of MM/DMC were prepared at 10 weight % DMC and 36 weight % DMC, balance MM in both cases. Dow Corning Medical Grade 360 silicone fluid (350 centistoke viscosity) was added in 1-gram increments and the mixtures shaken and observed for solubility. Both blends solvated 20 grams of the silicone fluid at which time the experiment was halted without determining the full solubility limit. This shows the utility of these blends as carrier liquids for depositing silicone materials. Generally, any material, such as a lubricant or coating which can be dissolved or dispersed in the MM/DMC blends of the present invention, can be deposited on surfaces using the MM/DMC blend as a carrier liquid. the MM/DMC blend will evaporate quickly, leaving behind a uniform coating of the lubricant or other coating material.

Another sample of the 36 weight % DMC/64 weight % MM blend was prepared and mixed with a hydrofluorocarbon liquid sold under the trademark Vertrel® XF by DuPont Fluorochemicals of Wilmington, Del. The resulting liquid contained 30 weight % of the MM/DMC blend and 70 weight % of the hydrofluorocarbon liquid. The hydrofluorocarbon-containing mixture was tested for flammability and found to be non-flammable, that is, the added MM/DMC blend in the amount of 30 weight % did not adversely affect the non-flammability of the Vertrel® XF hydrofluorocarbon liquid. Generally, any suitable additives may be added to the MM/DMC blends to suit a particular purpose.

It has been discovered that the blends of the present invention form an azeotrope or at least display azeotrope-like behavior because the blend evaporates faster than either of its individual components. In automated cleaning operations this is a significant advantage as it prevents “puddling” and wash-back of contaminated cleaning fluid onto cleaned areas.

While the invention has been described in detail with reference to specific embodiments, it will be appreciated that numerous variations may be made to the described embodiments, which variations nonetheless lie within the scope of the present invention.

What is claimed is:

1. An azeotropic or azeotrope-like blend of from about 90 weight % to about 10 weight % hexamethyldisiloxane (“MM”) and from about 10 weight % to about 90 weight % dimethylcarbonate (“DMC”).

2. The azeotropic or azeotrope-like blend of claim 1 comprising from about 20 weight % to about 90 weight % MM and from about 80 weight % to about 10 weight % DMC.

3. The azeotropic or azeotrope-like blend of claim 1 comprising from about 10 weight % to about 15 weight % DMC.

4. The azeotropic or azeotrope-like blend of claim 1, claim 2 or claim 3 comprising a binary azeotropic blend consisting essentially of MM and DMC.

5. A method of cleaning an article, the method comprising:
(a) contacting the article with a cleaning liquid comprising from about 10 to about 90 parts by weight MM and from about 90 to about 10 parts by weight DMC, and (b) removing the cleaning liquid from the article.

6. The method of claim 5 wherein step (b) comprises evaporating the cleaning liquid to remove it from the article.

7. The method of claim 5 wherein the cleaning liquid comprises a binary azeotropic blend containing from about 10 to about 90 weight % MM and from about 90 to about 10 weight % DMC.

8. The method of claim 7 wherein the blend contains up to about 50 weight % DMC.

9. A method of dispersing a substance onto an article, the method comprising:
(a) dispersing the substance into a carrier liquid comprising an azeotropic or azeotrope-like blend of from about 90 parts by weight MM to about 10 parts by weight DMC; and
(b) removing the carrier liquid to leave a coating of the substance on the article.

10. The method of claim 9 wherein step (b) comprises evaporating the cleaning liquid to remove it from the article.

11. The method of claim 9 wherein the cleaning liquid comprises a binary azeotropic blend containing from about 10 to about 90 weight % MM and from about 90 to about 10 weight % DMC.
